(19) United States
(12) Patent Application Publication
(10) Pub. No.: US 2004/0196181 A1
(43) Pub. Date: Oct. 7, 2004

(54) Method and apparatus for message display on a golf course

(76) Inventors: Charles D. Huston, Austin, TX (US); Darryl J. Cornish, Austin, TX (US)

Correspondence Address: Conley Rose, P.C., P.O. Box 684908, Austin, TX, 78768-4908, US

(21) Appl. No.: 10/772,071

(22) Filed: Feb. 4, 2004

Related U.S. Application Data
(63) Continuation of application No. 08/926,293, filed on Sep. 5, 1997, now abandoned.
Application No. 08/926,293 is a continuation-in-part of application No. 08/313,718, filed on Sep. 22, 1994, now abandoned.

(51) Int. Cl. G01S 5/14; A63B 57/00

(52) U.S. Cl. 342/357.06; 473/407; 342/357.08

(57) ABSTRACT

A method, apparatus. and system is described for displaying a message to a golfer on a golf course. The system includes a number of GPS receivers attached to carts (or handheld) which display golf information and/or messages. The GPS receiver includes a display which can show the distance to the golf cup or other feature on a golf hole. The display can show a message, such as an advertising message, to the golfer. The message is shown at convenient, nonintrusive times. For example, such messages are shown at predetermined locations on the golf course such as before the first hole, after the last hole, or between holes. Additionally, such messages can be displayed using location information to determine if the receiver is moving or stopped. Finally, such messages may be displayed based on the activity of the golfer, such as scorecard input or refreshment ordering. In a preferred form, a pen input display capable of graphics is used. The system also includes a pro shop monitor where the location of each OPS receiver is shown on the golf course. The pro shop can send messages to all receivers or individual receivers.

The present invention is a continuation-in-part of U.S. patent application Ser. No. 08/313,718 which is a continuation-in-part of U.S. Pat. No. 5,364,093 entitled “Golf Distance Measuring System and Method.”

### BACKGROUND OF THE INVENTION

1. Field of the Invention

The present invention relates to a method and apparatus for displaying advertising, promotion, and other types of messages on a screen used by a golfer on a golf course. In particular, the method and apparatus displays advertising messages to golfers based on the position or current activity of the golfer.

2. Description of Related Art

In the game of golf it is important to know as accurately as possible the distance between the golf ball and the golf cup on the green. It is sometimes also desirable to know the distance between the golf ball and a hazard on the hole being played. Knowing these distances allows proper club selection and allows a player to formulate a hole management plan. For example, a player that knows the ball is 110 yards from the pin would select the appropriate club for 110 yards such as a 9 iron or one of the players wedges.

Several methods and systems have been devised for determining and supplying such distance information to the golfer. U.S. Pat. No. 5,364,093 describes a method and system for using a Global Positioning Satellite system (GPS) for determining the position of a golfer on a golf hole and calculating the distance to a feature, green center, or pin placement on the hole. Other systems have been devised for determining distances on a golf course. For example see. U.S. Pat. Nos. 5,056,106; 5,086,390; 5,326,095; and EP App. No. 93900126

The displays on such golf position determining systems range from simple 3 segment LED's to graphical high resolution screens. In any event, it is desirable to use such displays for advertisements or player services at times when the display is not in use for its primary purpose—communicating playing information to the golfer. It is important that the times such advertising or service information are displayed is non-distracting, non-intrusive, and is tasteful.

Therefore, a method and apparatus which could display advertising or other player service messages at convenient, non-intrusive times would be advantageous.

### SUMMARY OF THE INVENTION

The problems outlined above are generally solved by the method and system of the present invention which, at convenient opportunities, uses a display accompanying a golfer for advertising, promotion, service, and other types of messages. The display is typically mounted on a golf cart and the position of the display is known (e.g. using GPS). The present method and system uses the position information to display advertising messages at predetermined convenient locations. For example, convenient locations may be prior to the first tee, after the last green, between holes, or when the golf cart is moving. Another convenient opportunity for displaying advertising messages is based on activity of the golfer. For example, if the golfer is inputting scores, advertising may be associated with celebrate events such as a low score. As used in the present application, advertising messages” is sometimes used to denote advertising, promotion, service, and other types of messages without implication of specific content of the message.

Preferably the system includes a visual display of the golf hole being played, including the location of the pin on the green, the bunkers protecting the green, the hazards on the hole, as well as a digital readout of the distance from the ball to the golf cup. In an enhanced version the display includes a light pen or pointing device (finger or pen for pressure sensitive screen) allowing the player to mark positions on the hole the green, but may be a nominal location, such as “middle” of the green or “front” of the green.

The error correction is determined by positioning a GPS receiver at a reference location having a known position. The GPS receiver determines an apparent position using the available global positioning satellites in view. The error correction is calculated based on the difference between the apparent position and the known position. The error correction is preferably broadcast periodically for use by the remote GPS receivers used by the golf players. Preferably, the position of the golf cups on the greens are determined by placing a GPS receiver in or near the cup (e.g. before play by the greens keeper), determining an apparent position, and applying the error correction to obtain the golf cup position stored for use during play.

In the preferred embodiment, a base station is placed at the known position to continuously calculate and transmit the error correction. The remote receivers are optionally configured to periodically transmit their position to the base station so that the course marshal can continuously monitor the progress of play.

In an alternative form, the remote receiver is used to calculate an error correction for its own use. For example. a remote receiver mounted on a golf cart would be driven onto a placard designating a known location on each hole. The apparent GPS position of the remote receiver over the placard is compared with the known position to calculate an error correction for use during play.

### BRIEF DESCRIPTION OF THE DRAWINGS

FIG. 1 schematically illustrates the display of the preferred embodiment of the remote unit;

FIG. 2 is a block diagram of a remote unit including a GPS receiver in accordance with the present invention;

FIG. 3 is a block diagram of the base station in accordance with the present invention;

FIG. 4 is a schematic of the packet radio network used to transmit the error correction;

FIG. 5 schematically illustrates the display of FIG. 1 at an opportune location on the golf course where an advertising message is depicted;

FIG. 6 is a diagram of the display of FIG. 1 where a scorecard module with an advertising message is appended;

FIG. 7 depicts the layout of an alternative embodiment of the control panel and display of the remote unit;

FIG. 8 is a block diagram describing an alternative embodiment of the remote unit which includes an internal calibration mechanism;

FIG. 9 illustrates the pro shop monitor of the preferred embodiment;

FIG. 10 is a block diagram depicting an alternative system where the remote units act as repeaters; and

FIG. 11 schematically illustrates the display of FIG. 1 where directions and an advertising message are depicted.

### DESCRIPTION OF THE PREFERRED EMBODIMENTS

The present invention utilizes a global positioning satellite system. such as Navstar or Glonass (GPS) to determine the approximate distance from a golf ball to hole features, such as the cup or pin on the green of the golf hole being played. GPS is a space based system of satellites which can provide, to an infinite number of receivers, accurate three dimensional position (i.e. horizontal location and altitude), velocity, and time. A general understanding of GPS is useful to appreciate the operation of the present invention. Numerous books and articles are available on GPS operation and theory. See e.g., GPS—A Guide to the Next Utility, Trimble Navigation (incorporated by reference for background).

The Global Positioning Satellite System

The GPS system is an umbrella of satellites circling the earth passively transmitting signals. Each satellite has a very accurate atomic clock which is periodically updated. A GPS receiver with an accurate clock can identify a satellite and determine the transit time of the signal from the satellite to the receiver. Knowing the transit time and knowing that the speed of light is 186,000 miles per second enables a calculation of the distance from the satellite to the receiver. The signal carries with it data which discloses satellite position and time of transmission, and synchronizes the GPS system with satellite clocks.

If a GPS receiver can locate 3 or 4 satellites it can determine its distance from each satellite. The intersection of these 3 or 4 spheres enables a precise location of the receiver (and some compensation for timing errors in the receiver's internal clock). The GPS system should have 21 satellites and 3 spares once the system is fully deployed. Currently about 14 satellites are deployed, giving reasonable satellite coverage worldwide for most of the day.

There are basically two types of GPS receivers—P (precision) code and C/A (coarse availability) code. P code is generally for government use and requires specialized equipment. C/A code receivers are becoming widely available with the continuing deployment of OPS satellites. One difficulty with C/A code receivers is that the government from time to time intentionally degrades the satellite signals—so called “selective availability.” With selective availability turned on, horizontal accuracy is on the order of 50-100 meters. With selective availability disabled horizontal accuracy can improve to around 15 meters.

First Embodiment

Turning to the drawings, the system of the present invention includes a remote unit 10. base station 12. and cup locator 14. A remote unit 10 accompanies the golfer during the round—for example mounted on the golf cart.

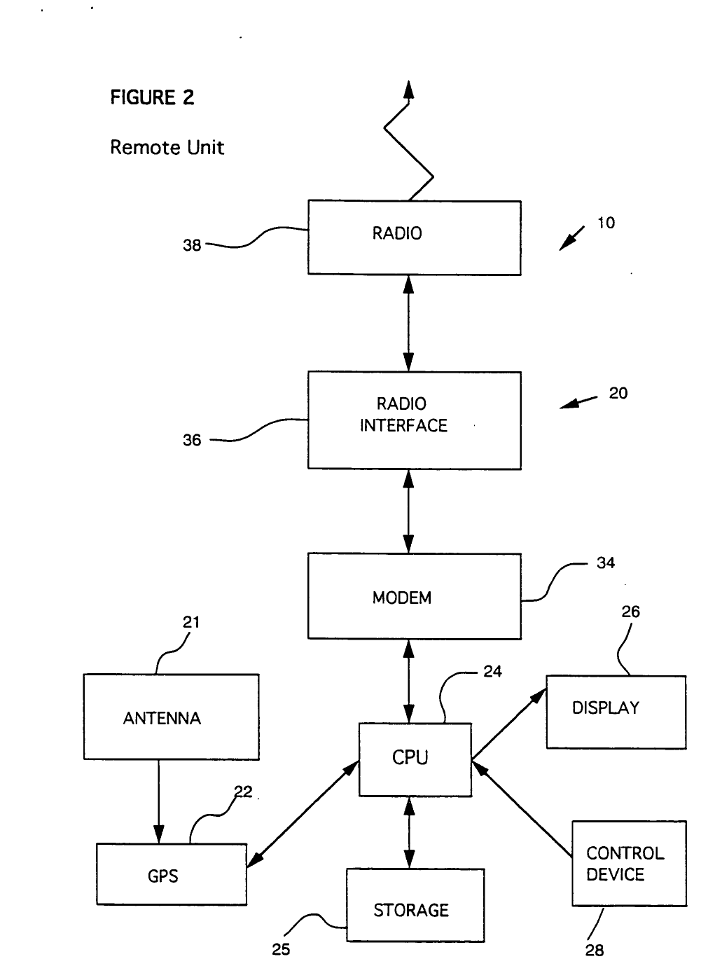

As shown in FIG. 2, the remote unit 10 includes a packet radio system 20, a GPS antenna 21 and receiver 22, a CPU 24, storage 25, a display 26, and a control device 28. The GPS receiver 22 is preferably a multi-channel receiver such as the SV-6 Model made by Trimble Navigation of Sunnyvale, Calif. Other commercially available substitutes are acceptable such as made by Magellan or Rockwell/Collins. The antenna 21 is either remote or internal to the receiver 22, but in any event is mounted on the golf cart for an upward look angle for optimum OPS signal reception.

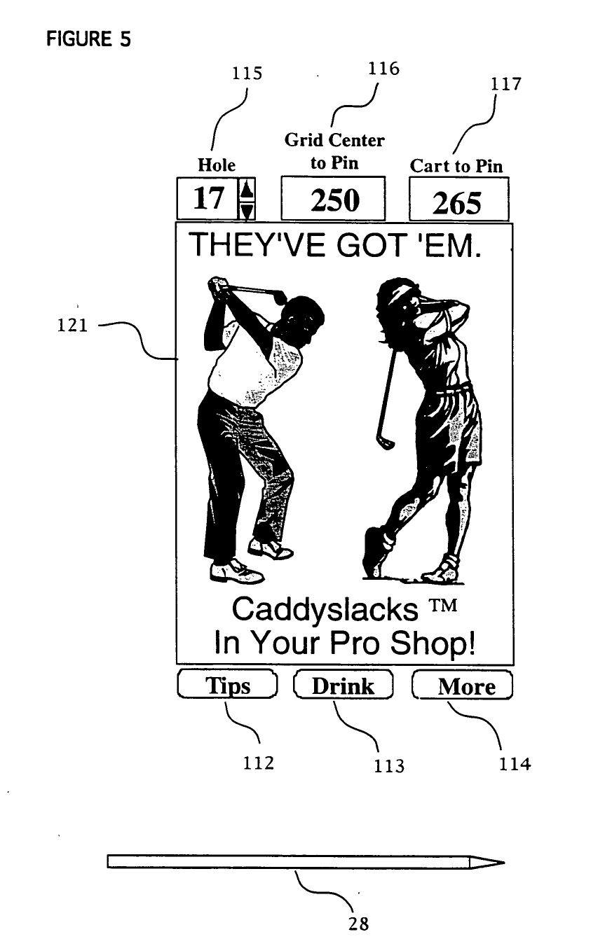

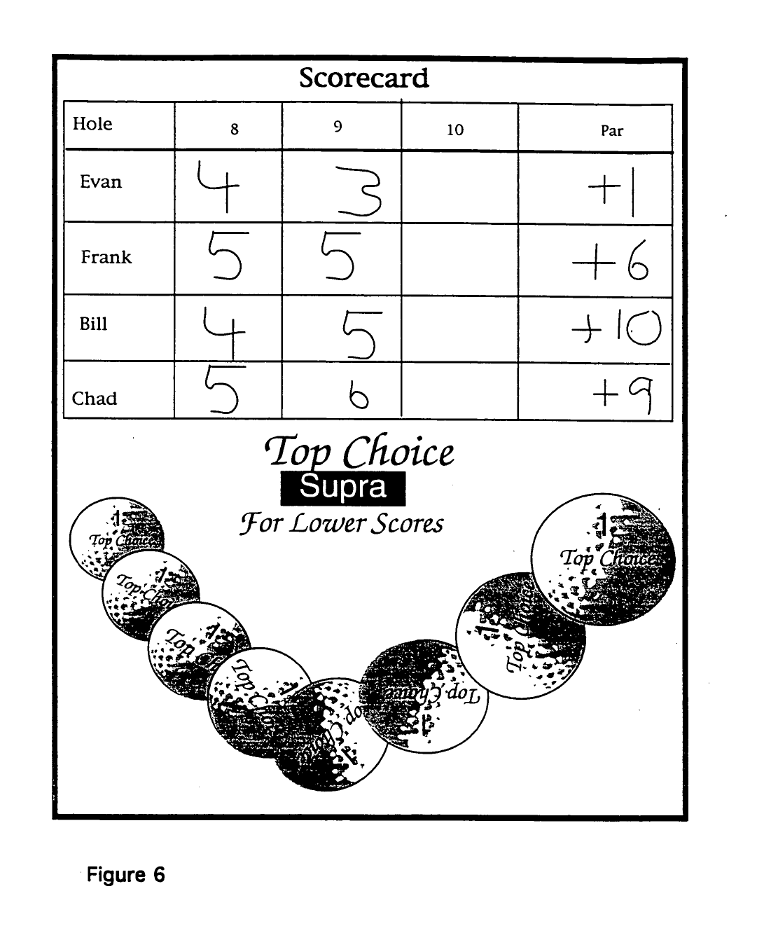

As shown in FIG. 2, the remote unit 10 includes a CPU 24, control device 28, nonvolatile memory storage 25, as well as the radio interface 20 and GPS engine and antenna 22, 21. In the preferred remote unit, the CPU 24, memory storage 25, and display 26 are integral, such as the PDA or pen tablet referenced above, and are collectively referred to as the display 26. The memory storage 25 includes the internal RAM and the PCMCIA cards incorporated with such a PDA or pen tablet. Of course, integration or segregation of the components of FIG. 2 is a simple matter of design choice. Preferably, the advertising messages (e.g. FIGS. 5, 6) are stored on the PCMCIA cards (memory 25) so that large data graphic advertising messages can be easily stored and replaced.

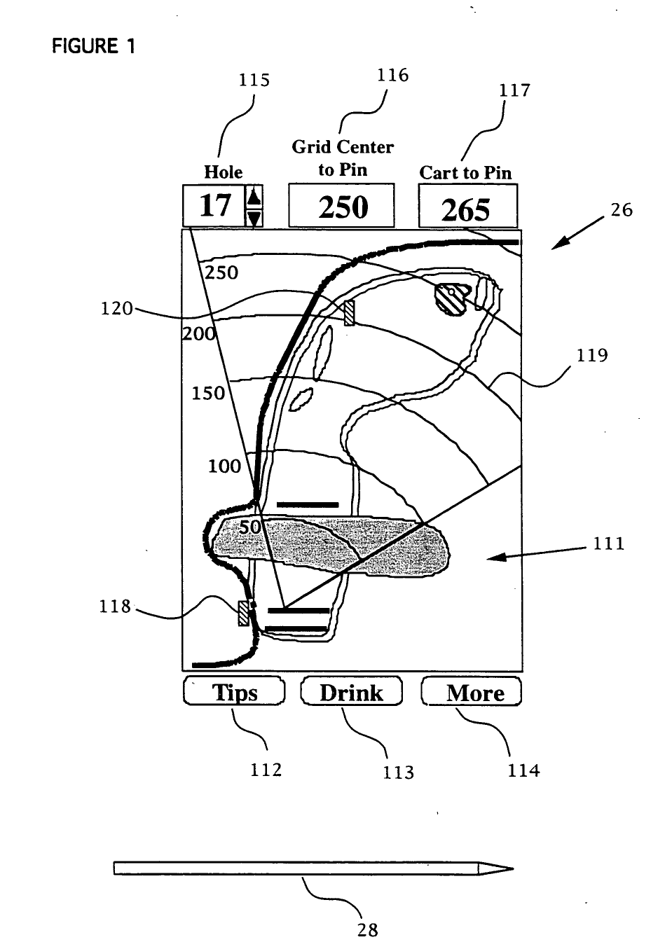

The display 26 of the preferred embodiment, illustrated in FIGS. 1 and 2, is a pen input display. The pen input display 26 is mounted on the golf cart and permits the user to directly input commands with the control device or pen 28. Preferably, the pen display 26 is a Personal Digital Assistant (PDA) such as the Apple Newton. Alternatively, the pen display 26 may comprise a pen tablet computer, either monochrome or color, such as made by Fujitsu, IBM, Toshiba, and others.

As can be seen in FIG. 1, the display :6 includes: a depiction (i.e., graphic representation) of the layout of the hole 111; option buttons 112-114; and indicators 115-117. An icon 118 represents the location of the remote unit (cart) 10 on the hole being played. A grid 119 comprising distance arcs and distance symbols (50-300 yards in FIG. 1) is overlaid on the hole layout 111. The option buttons 112-114 allow access to other functions and the indicators 115-117 display as labeled.

In FIG. 2, the packet radio system 20 is conventional, and includes modem 34, radio interface 36, and radio 38 (including an antenna, not shown). The radio system 20 is bidirectional in that it can receive error correction and other information as well as transmit present position and messages back to the base station 12. A PAC-COM, Inc. (Orlando, Fla.) packet radio modem 2400 baud for use with any commercial half duplex radio is believed preferable for the modem 34.

As an alternative to the bi-directional radio system 20 of FIG. 2, the radio system 20 may be unidirectional for simply receiving an error correction (or other message) broadcast to all remote units 10, e.g. over FM frequencies. The ACTT receiver chip set made by Seiko is believed preferably. The ACTT chip combines most of the components of the radio system 20 on a single, low cost, low power chip which is currently only a receiver. This alternative is particularly suited for hand-held remote units 10 (vice cart mounted).

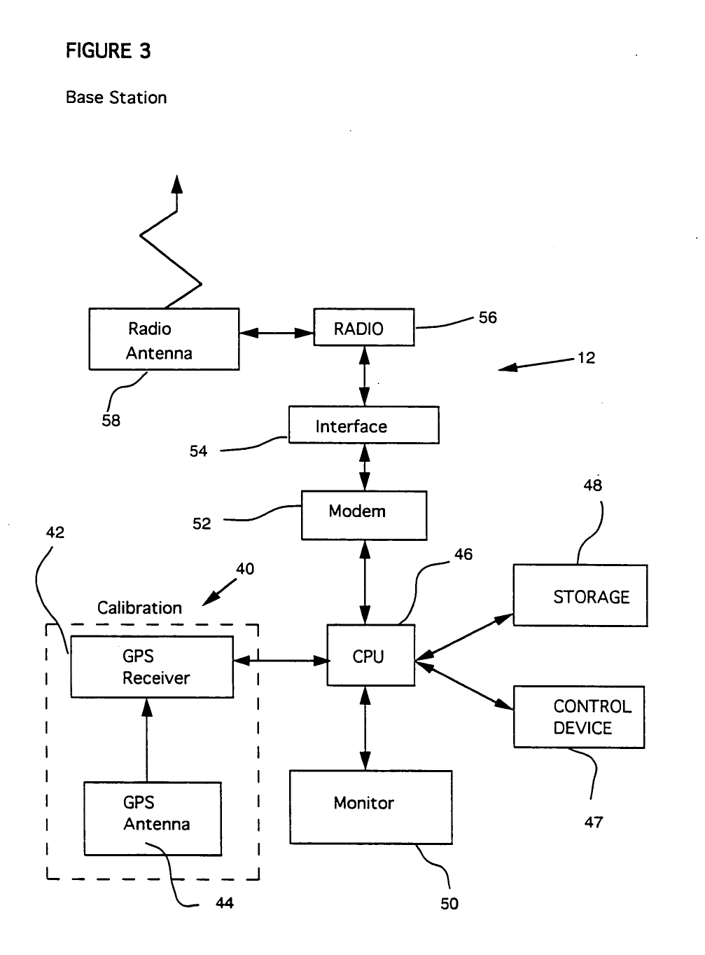

FIG. 3 illustrates the base station 12, which is desirably placed in or near the pro shop. The base station 12 includes a calibration section 40 which comprises a GPS receiver 42 and antenna 44. The calibration section 40 continuously determines apparent position of the antenna 44 and feeds this information to CPU 46. The CPU is conventional, such as a 486 type personal computer operating a 66 MHz. The control device 47 preferably includes a mouse and a standard keyboard.

The course geography database 48 is similarly connected to the CPU 46 and stores course information such as hole layout and the present position of the cups on the greens for the day. A monitor 50 is coupled to CPU 46 and is useful not only for initialization, but also is selectable to display the present position of all the remote receiver units 10 on the course. The base station 12 includes a packet radio system similar to FIG. 2 coupled to the CPU 46, and comprises modem 52, interface 54, radio 56, and radio antenna 58.

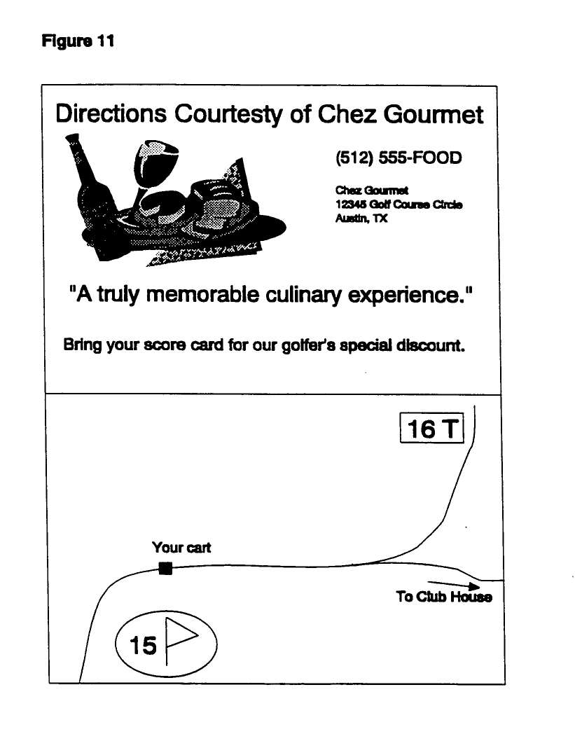

The monitor 50 is capable of displaying the golf course 130 as shown in FIG. 11. The remote units (carts) 10 are shown on the various holes and represented as “plus” icons in FIG. 11 color coded as shown. The “$” symbol represents a service request as shown, such as a cart requesting beverage service.

A Cup Locator may be used to precisely locate daily cup location (i.e., pin placement) nearly identical to the remote unit of FIG. 2. A CPU is coupled to a GPS receiver and includes an antenna for receiving GPS signals. Memory (such as RAM and a PCMCIA card) is coupled to the CPU and stores the location of each cup as the cup locator is moved from green to green. The location of each cup may alternatively be transmitted to the base station 12 using a modem, radio interface, and radio 72.

Operation

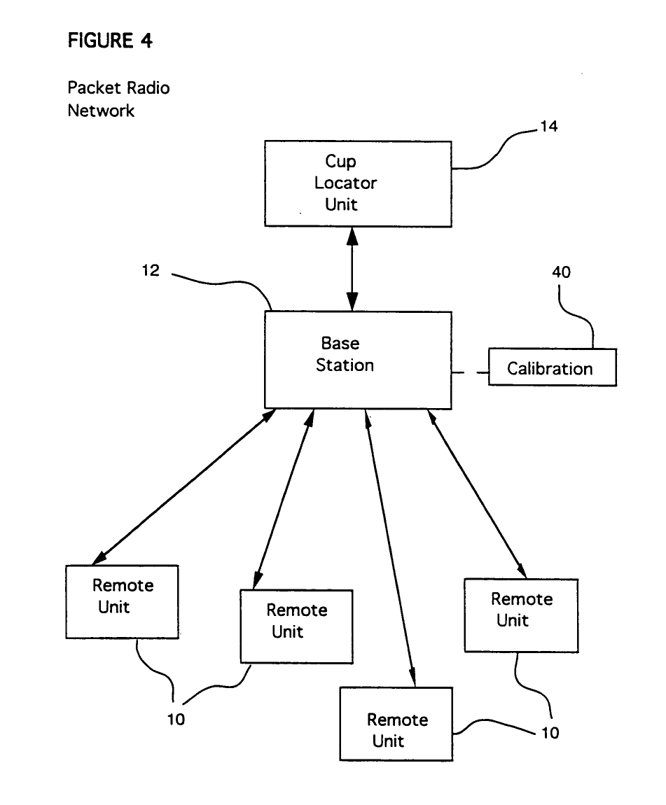

FIG. 4 illustrates schematically the operation of the system of the present invention. The cup locator unit is transported from green to green when the location of the cups are changed. The greens keeper positions the cup locator unit near the new cup and allows a few seconds for the GPS receiver to determine an apparent cup location. The longer the greens keeper permits acquisition the more samples are obtained and accuracy is increased. The first cup might take several minutes while the GPS receiver consults its almanac and locates the satellites in view, a so-called “cold start.” Determining the location of the cups should take only a few seconds to determine an apparent location once the GPS receiver has operated for several minutes. Because the GPS receiver of in the cup locator is a C/A code receiver, its accuracy is about 15 meters (selective availability disabled) with a worst accuracy of about 100 meters.

The greens keeper turns on the cup locator and the position of the cup locator is sampled for as longs as it takes for the greens keeper to change cups. Preferably, the timing signals from the 4-10 satellites in view are stored in a memory of the cup locator. Accuracy is improved by letting the cup locator acquire multiple samples of each satellite timing signal. The apparent cup locations are downloaded and stored in a course geography database in the storage 48 of FIG. 3. Additionally, the course layout is stored in the database 48. After the cup apparent locations are downloaded an error correction is applied to obtain a corrected position for each cup. The corrected position is preferably transmitted over the packet radio system to update the memory 25 of each remote unit 10 before play.

In the preferred embodiment, the uncorrected or apparent cup locations are loaded into the base station computer 46 for so-called “post processing” error correction. That is, using conventional differential techniques. the timing signal for each satellite for each apparent location is compared with the same satellite timing signal for the apparent position of the base station. In this fashion, a very accurate correction for each timing signal for each satellite can be computed at the base station for the time the apparent cup locations were acquired. Each apparent cup location may have associated with it many (e.g. 4-10) satellite timing signals. Correcting these timing signals gives very accurate cup locations. Conventional surveying differential correction can achieve cup locations with an accuracy of several centimeters by looking at carrier phase and other known parameters. It is believed that simple position correction of the timing signals will achieve accuracies on the order of 0.25 meter which is believed sufficiently accurate for the present application. See e.g., Differential Correction, by Trimble Navigation (incorporated by reference for background).

Correcting the apparent cup locations as accurately as possible is advantageous. Without correction, the following error are present: satellite clock error; receiver error; atmospheric/ionospheric errors; selective availability errors (if enabled); and ephemeris errors. Because these errors change over time, it is necessary during post processing to apply the timing signal corrections for the time the apparent cup locations were acquired.

Alternatively, the apparent position of the respective cup may be transmitted to the base station and also stored in memory. FIG. 4 shows schematically the passage of the radio transmission over the packet network to the base station 12. Typically, the greens keeper would return to the base station after the cups are changed and verify that the cup information had been transmitted correctly—if not, the cup information stored in memory 66 would be downloaded to the base station 12.

In this alternative, the calibration system 40 operates to calculate and apply an error correction to the cup apparent locations as they are received over the packet radio system at the base station 12. These corrected cup locations are stored in the course geography database for later use. In this alternative method, the error is minimized by minimizing the time between acquisition and application of the error correction. By transmitting apparent cup location over the packet network and immediately applying an error correction, all GPS receivers are primarily observing the same satellites and have the same errors. Of course, the post processing method of the preferred embodiment is more accurate.

As shown in FIGS. 3 and 4, during normal play the base station 12 performs continuous calibration. During calibration, the GPS receiver 42 continuously calculates its apparent position. The antenna 44 is placed at a known location. The difference between the apparent position and the known location is the current error correction. This technique is known as “differential GPS” and has been applied in land surveying techniques. Because the satellites are so high compared to the distance between the cup locator receiver 62 and the calibration receiver 44, this differential error correction accounts for most of the possible errors in the system. In the preferred embodiment, the error correction may comprise a vector or position correction which is reasonably accurate if the remote units are using the same satellites as the base station to find apparent position. Alternatively, the error correction comprises a timing correction or “delta” for the timing signals of the satellites in view. With an uncorrected accuracy of 10-15 meters, the calibrated or corrected accuracy is less than 5 meters in all cases, and normally approaches 1 meter accuracy.

When players are on the course, the current error correction is transmitted periodically to all remote units 10 on the packet radio network (FIG. 4). Preferably, once every five to fifteen seconds a small time window (e.g. 0.5 second) is opened on each remote unit 10 for reception of the current error correction.

Turning to FIG. 2 the remote unit is preferably mounted on a golf cart. Current hardware technology dictates a size, weight, and power requirement that makes golf cart mounting the most feasible. However, miniaturization should enable an embodiment that is hand held in the near future.

The remote unit 10 preferably continuously operates to calculate the distance from the unit 10 to the cup on the hole being played. The GPS receiver 22 determines an apparent position and then reads the current error correction stored in memory 25. The CPU 24 applies the current error correction to the apparent position to calculate a corrected position. The corrected position is compared to the corrected cup location retrieved from memory 25 and the difference is determined and shown as the distance to the pin on display 26. In the preferred embodiment the error correction comprises a number of timing signal corrections for particular satellites useful during the 15 second calibration loop. The CPU 24 applies these timing signal corrections to its apparent position timing signals.

Use of the display of FIG. 1 is matched to the players abilities. If the player does nothing, the grid 119 is displayed every time the cart (i.e. remote unit) 10 stops and has its origin at the cart. In this case, both indicators 116 and 117 display the same number which is the distance from the cart to the cup location. By looking at the grid, the player can also tell approximate distances to other features, such as the distance to carry a hazard or to lay up short of a hazard. The cart symbol 118 is always present and shows the position of the cart on the hole layout 111. When the position of the remote unit approaches the tee of the next hole, the display automatically switches to the next hole. Alternatively, the player may touch the arrows of the “Hole” indicator 115 with the pen 28 to increment (or decrement) the hole being played—i.e. when hole 17 is complete the player touches the top arrow of indicator 115 to increment and display hole 18.

The preferred embodiment employs a method to determine if the cart is stopped. If the cart is stopped, the grid 119 snaps onto the display and the cart (remote unit 10) does not re-transmit its location to the base station 12 (to reduce bandwidth requirements). Additionally, when stopped, the GPS receiver 22 may begin averaging apparent position measurements to obtain a more accurate “apparent position.” The method to determine if the cart is stopped compares the apparent positions of the cart (typically 2 samples) to a predetermined error (Derror) (for this application 1.5 meters is used). If both samples are within Derror, then the cart is assumed to be stopped. Selective availability error (Derror) is believed to be not more than 1 meter per 5 seconds and, although random, the 2nd sample would be within 1 meter of the 1st sample if the cart is stopped. If the 2nd sample is greater then 1 meter, then the cart is assumed to be moving, and the 2nd sample becomes the new current apparent position.

If the player chooses to use the expanded features, more options are available. If the player touches the hole layout 111 with the pen 28, the grid snaps to the location touched and the indicator 116 indicates the yardage to the pin from the apex or origin of the arid. In FIG. 1, the player has touched the middle tee box where the player will place the ball) to more accurately judge distances to hazards. This feature is particularly useful for hole, shot planning, or estimating driving distance. For example, the player might touch the hole layout 111 between the 150 and 200 yard grid arcs to determine a target 110 yards from the pin for hitting the player's next shot.

Another feature is the icon 120 depicting the nearest cart of the group playing ahead. As can be seen, the icon 120 is about 230 yards ahead, so tee-off can safely be made if no club is expected to approach the 230 yard distance. This ability to determine distance to the cart ahead speeds up play while preserving game etiquette, and is particularly useful where the cart ahead cannot be seen, so-called blind holes. The preferred embodiment simply shows all carts (remote units) 10 on the hole being played.

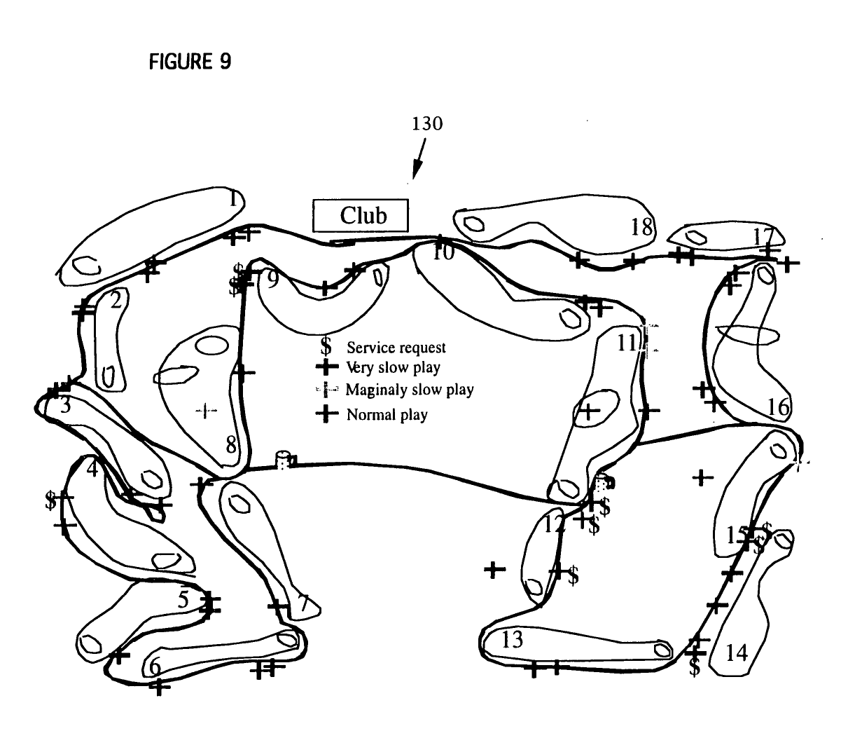

The option buttons 112-114 allow the player to access “tips” (e.g. caddie hints), “drinks,” and “more” respectively. The tips are just that—memory storage 25 contains caddie hints for the current location of the cart. For example, here the hint might state “aim between the far trap and the green and carry the trap.” The “more” menu allows the player to access other options such as a scorecard, where the player can enter scores for the round for each player or food service. Such a scorecard is shown in FIG. 6 where the pen input shows the score numerals as digital ink. If desired, the scores can be transmitted over the radio network and downloaded to the base station 12 for handicap input and is particular useful during tournaments. The “drink” button allows the player to order drinks, either for immediate delivery or not. As shown in FIG. 9, if a player requests immediate food or beverage, the monitor 130 reflects the request and the delivery person can be dispatched.

In the preferred embodiment the remote unit 10 calculates and displays a distance from the unit 10 to the cup (or an arbitrary green location), it receives a current error correction every 5-15 seconds and, additionally, transmits a current position to the base station every 5-15 seconds. This allows the course marshal or pro to view the monitor in FIGS. 3 and 9 to consider the position of every remote unit on the course.

As shown in FIG. 5, a graphic advertising message 121 is displayed at convenient or opportune times. The remote unit 10 shows advertising at convenient times based on the location of the remote unit 10 on the golf course. For example, an advertising message 121 may displayed while the carts are awaiting players loading clubs onto the cart and prior to the first tee box. The advertising message 121 may also be displayed after the 18th green. Additionally, the advertising message 121 may also be displayed at non-intrusive times, such as when the remote unit 10 is between the green of a hole and the next tee. Of course, different messages can be stored in memory 25 (e.g. PCMCIA card) for display at different locations.

While the remote receiver 10 (e.g. golf cart) is moving, the golfer is not likely to need all of the information on the display 26. For example. the golfer will not be interested in exact distance from the cart to the pin 117 or grid center to pin 116 while the remote receiver is moving. This screen area could be used for advertising or other messages while the cart is moving, such as in FIG. 5.

While driving between holes, it would be possible to put up a map showing how to get to the next hole, with an ad that is relevant to the time of day, and the fact that the golfer is approaching a specific point in the course. FIG. 11 shows an ad that gives directions to the 16th tee, knowing that the golfers will soon be finished their round and that it is after 4:00 PM so they will be looking for a place to eat.

Using the “More” key 114 (FIGS. 1 and 5), a “services” and products” menu is displayed at the request of the user. Services could include advertising for course amenities, local restaurants, shops, etc. as shown in FIG. 11. Products could include specific advertisements for products available in the local area.

FIG. 6 shows the display of an advertising message based on the activity of the golfer. In FIG. 6, the golfer's activity is keeping score and a static message is displayed on the display 26. Such activity might be scorecard input, refreshment ordering, bet tracking, etc. Alternatively, a dynamic message can be displayed—e.g. a message reacting to a good score (or bad!) on the hole.

Second Embodiment

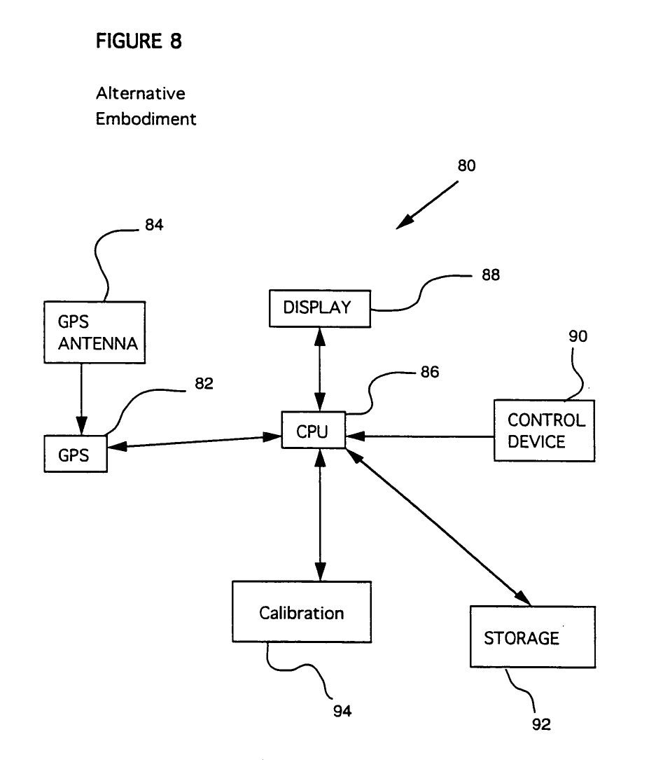

FIG. 3 illustrates an alternative embodiment remote unit 80 which is preferably mounted on a golf cart or hand carried. In the system of FIG. 8 the base station is eliminated as well as the packet radio system. The remote unit 30 includes a GPS receiver 82, GPS antenna 84, CPU 36, display 38, control device 90, storage 92, and calibration 94. The hardware may be the same as in the preferred embodiment, but for the hand carried remote unit power requirements is a factor in hardware selection.

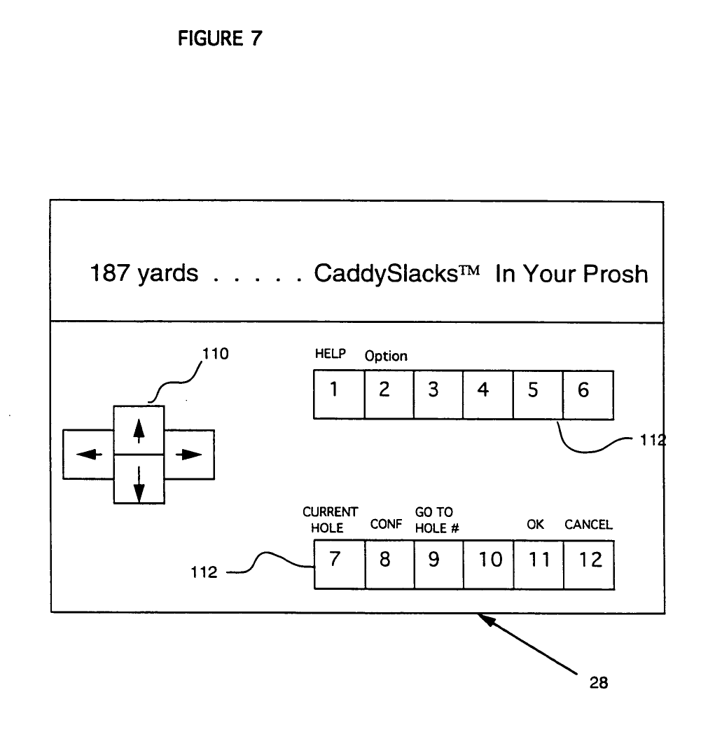

In particular, the storage 92 similarly contains a course geography database and advertising messages but, in addition, contains the location of a calibration location for each hole. Such a calibration location is preferably a placard on the ground in the cart path adjacent the tee box for the hole being played. In the alternative embodiment, a control device like FIGS. 1 or 7 is used with keypad “6” being additionally labeled with the notation “Calibrate.” The calibration box 94 in FIG. 8 is preferably EEPROM and contains the calibration routine. Of course the calibration routine could alternatively be stored in Storage 92.

In use, the present position of the cups for each hole is loaded in the course geography database in storage 92. Preferably the cup locator is used with the packet radio system eliminated. The cup locations are stored in memory 66 and transferred to the remote unit 80. Without calibration and with a C/A code receiver 82, the remote unit 80 will give distance accuracies within 100 meters (S/A enabled) and within 20 meters (S/A disabled). Of course technical improvements in GPS technology might improve on this accuracy to some degree.

To improve these accuracies a calibration procedure is utilized. The golfer places the remote unit 80 over a placard in the cart path, calls up the display for the hole being played, and presses “Calibrate” pad 6. A calibration routine is initiated, and an error correction is determined by comparing the current apparent GPS position with the GPS position stored for the hole placard. This calibrate procedure gives a reasonably accurate error correction for the duration of play for the hole. If a player forgets to calibrate for a hole the previous error correction is simply carried over and applied.

Accuracy is largely dependent on the desires of the golfer. With Selective Availability disabled (or perhaps with a wide area differential correction or pseudolite) accuracy within 1 meter should be possible on most holes if a calibration is performed every hole. If the system is calibrated by the pro shop before play, accuracy is estimated to be quite good (e.g. <3 meters) for several hours until new satellites come into view and use.

Third Embodiment

FIG. 7 illustrates another embodiment of the control device 25 and display 26. The twelve function keys 112 operate to function as labeled. The display is a simple. low cost LED or LCD alphanumeric screen. Player information, such as distance to pins or caddy tips can be displayed based on current location of the remote unit 10. Additionally, at convenient times (location or activity) an advertising message may be displayed such as shown in FIG. 7. While a pen based control system might be preferable functionally to the device 28 illustrated in FIG. 7, the cost of the device 28 and display 26 may be considerably less.

Fourth Embodiment

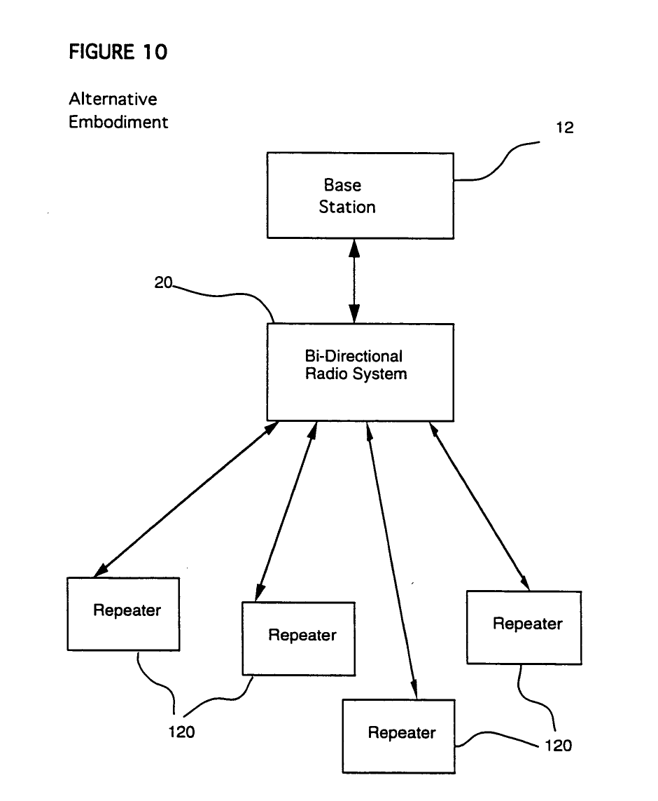

This embodiment is illustrated in FIG. 10. The GPS “engine” is eliminated in the remote units. Rather, each remote unit 10 comprises a GPS repeater, such as a Tidget GPS sensor made by Navsys Corp. of Edinburgh, Scotland. The repeater 120 operates to receive the GPS raw data timing signals from the GPS satellites, digitize and compress the timing signals. Preferably, the repeater 120 can be set to look at a certain number of satellites, e.g. 5 satellites. The satellite timing signals are not processed. Instead, the signals are amplified and periodically relayed to the base station 12. Different signal processing techniques may be employed if desired, such as filtering and compressing. The base station collects each timing signal from the repeaters and processes the timing signals to determine a location of the repeater.

The base station 10 can employ the amount of processing desired to the timing signals to improve the accuracy estimation of the repeater—commensurate with the time available, the processing load, accuracy desired, etc. If desired, a distance to the green cup for the repeater can be transmitted and displayed on the cart of the repeater.

In FIG. 12 a preferred embodiment of such a repeater system is illustrated. Each repeater 120 includes an identification. Each repeater 120 is allocated, for example. an 80 millisecond transmit and a 20 millisecond receive time window. Because the base station 12 and all of the repeaters 120 have accurate GPS timing signals, such a time window allocation is possible. A repeater 120 receives timing signals from 4 satellites and stores the signals in a temporary memory buffer (compressing if desired) for transmission in its allocated time window. The timing signals include an identification of the satellite.

The base station 12 receives the timing signals from a certain repeater 120 in the repeater's allocated timing window. The base station has already co-processed a timing correction for each satellite timing signal and, therefore, can apply the correction upon receipt of the repeater timing signal. The repeaters 120 are receiving the timing signals from predominantly the same satellites, so the base station needs to only keep a current correction for a limited number of satellites. Using the corrected timing signals, the base station can accurately process the repeater timing signals to derive a location of the repeater on the golf course.

This embodiment uses the repeater location and compares the location with a database of golf cup locations (or an arbitrary location on the green such as center of the green). The difference is the distance from the repeater 120 to the cup location. This distance is transmitted to the repeater 120 in the 20 millisecond time window allocated for that repeater. The distance is displayed on the cart to give the golfer a distance to the pin estimation.

This embodiment contemplates the use of time windows to avoid the communication overhead associated with hand shake protocols. With this method, it is believed that repeaters on 50 carts may transmit their timing signals and receive a distance to the pin estimation with an update rate every 5 seconds. From the golfers perspective, a new distance to the cup estimation is displayed every 5 seconds. In the pro shop, the position of the carts on the course is refreshed every 5 seconds.

Alternative configurations of this embodiment exist in many forms. For example, the repeater may take the form factor of a digital pager and even be hand carried. Additionally, instead of allocating time windows, the repeater 120 may include a query button which upon activation by the golfer transmits the latest satellite timing signals which are immediately processed and the distance estimation returned.

It should be readily apparent that a primary advantage of this embodiment is reduced cost of the remote receiver hardware. A repeater with a communications link and a simple LED display is all that is required as the remote unit. Another advantage is the small size possible and reduced power requirements. Disadvantages are the processing load required at the base station, a heavy communications load, and the dependence on the communications link.

Fifth Embodiment

With the advent of inexpensive higher resolution displays, this embodiment contemplates distance estimations from the remote unit to the golf cup location without the use of GPS or other location identifier (e.g. Loran or radio triangulation) in the remote unit. A pen display such as shown in FIG. 1 is used, preferably with a resolution greater than 1020×680 pixels. For a 500 yard golf hole length, this gives about 2 pixels per yard; for a 200 yard golf hole there are about 5 pixels per yard.

For example on the 500 yard golf hole, the golfer is about 200 yards from the green and accordingly touches the display with the pen at the approximate location of the ball on the display. The display immediately zooms to include the portion of the golf hole from the green to the designated location plus about 10%. In this example, the portion of the golf hole display after the zoom is approximately 220 yards. With the new 220 yard display, the golfer can redesignate the location of the ball on the display with the pen 28. The redesignation is obviously more accurate because there are now about 5 pixels per yard. Golfers can be expected to designate their position on a display within 20 pixels, so the error in designation is within 4 yards.

To improve accuracy, the location of the golf cup on the green is preferably loaded into a database in the remote unit. That is, a GPS unit is used to survey the location of the golf cup on the green within 1 yard and this database is loaded whenever the location of the cups are changed. If center of the green locations are used as nominal cup locations, accuracy is degraded.

Alternative Embodiments

Other alternatives are of course possible. By way of non-limiting example, the display 26 can be replaced with a simple LED which only displays distance from the remote unit to the cup. Additionally, the cup locator unit 14 can be eliminated with the greens keeper simply manually entering the approximate grid coordinates of each cup into the base station 12. Obviously, if the course does not want to set in the approximate grid coordinates of each cup, a nominal grid coordinate, e.g. center or front of the green, can be entered for each green, but accuracy is obviously reduced. The term “cup position” or “cup location” should be understood to include a measured location or a static grid location, such as nominally the center of the green. The terms “cup” and “pin” are often used interchangeably in this application. “Global Positioning Satellite System” includes the U.S. Navstar system, the Russian Glonass, and future analogous systems, such as the proposed system of the European Community.

We claim:

1. A method for displaying a message to a golfer on a golf course using the global positioning satellite system comprising the steps of:
positioning a remote global positioning satellite receiver on the golf course;
determining a position of the remote receiver on the golf course using the global positioning satellite system; and
displaying the message to the golfer at predetermined locations based on the position of the remote receiver.

2. The method of claim I, said message comprising an advertising message to the golfer.

3. The method of claim I, including the step of determining if the remote receiver is moving using said position and displaying said message when the remote receiver is moving.

4. The method of claim 3, the step of determining if the remote receiver is moving including the substeps of determining another position of the remote receiver and comparing said position and said other position to determine if the remote receiver is moving.

5. The method of claim 1, said message comprising a graphic depiction.

6. The method of claim 1, the displaying step including displaying a golf hole layout on said golf course at other locations on the golf course.

7. The method of claim 1, the displaying step including displaying golf information in addition to said message at other locations on the golf course.

8. The method of claim 7, said golf information comprising a scorecard and said message comprising an advertising message.

9. The method of claim 7, said golf information comprising a refreshment order page and said message comprising an advertising message.

10. The method of claim 1, including the step of determining the approximate distance of a golf ball to a feature on the golf course including the substeps of storing the location of the feature in a database, positioning the remote receiver proximate to a golf ball. and determining the distance between said stored feature location and said remote receiver position.

11. The method of claim 1, including the step of determinin2 an error correction for the global positioning satellite system comprising the substeps of:
positioning a global positioning satellite receiver at a reference location having a known position,
determining the apparent position of the reference location using the receiver, and
calculating an error correction based on the apparent position and the known position of the reference location.

12. An apparatus for displaying a message to a golfer on a golf course using the global positioning satellite system comprising:
a global positioning receiver means for receiving signals indicative of the apparent position of the receiver means using the global positioning satellite system and positionable on the golf course;
means linked to said global positioning receiver means for determining the position of the receiver means on the golf course; and
display means for displaying the message to the golfer.

13. The apparatus of claim 12, said display means being operable for displaying a graphic representation of said message.

14. The apparatus of claim 13, said display means including digitizer means overlaying said graphic representation and a pen operable for providing inputs to said display means.

15. The apparatus of claim 12. said display means being operable for displaying a graphic representation of a golf hole to the golfer.

16. The apparatus of claim 12, said apparatus including memory means for storing different advertising messages and means for displaying different messages at different positions of the receiver means on the golf course.

17. The apparatus of claim 12, including means for communicating messages to the display.

18. The apparatus of claim 12, said display being connected to the global positioning receiver means for displaying the message at predetermined positions of the receiver means on the golf course.

19. The apparatus of claim 12, said display being operable for displaying the message based on the activity of the golfer.

20. The apparatus of claim 10, wherein said activity is a golf score input.
